(19) United States
(12) Patent Application Publication
(10) Pub. No.: US 2014/0348571 A1
(43) Pub. Date: Nov. 27, 2014

(54) JOINING BULK METALLIC GLASS SHEETS USING PRESSURIZED FLUID FORMING

(71) Applicants: Christopher D. Prest, San Francisco, CA (US); Joseph C. Poole, San Francisco, CA (US); Matthew S. Scott, Campbell, CA (US); Dermot J. Stratton, San Francisco, CA (US); Stephen P. Zadesky, Portola Valley, CA (US); Richard W. Heley, Palo Alto, CA (US)

(72) Inventors: Christopher D. Prest, San Francisco, CA (US); Joseph C. Poole, San Francisco, CA (US); Matthew S. Scott, Campbell, CA (US); Dermot J. Stratton, San Francisco, CA (US); Stephen P. Zadesky, Portola Valley, CA (US); Richard W. Heley, Palo Alto, CA (US)

(21) Appl. No.: 14/352,401

(22) PCT Filed: Oct. 21, 2011
(86) PCT No.: PCT/US2011/057255

§ 371 Date: Jul. 2, 2014

(51) Int. Cl. B23K 1/00; C22C 45/00

(52) U.S. Cl. CPC B23K 1/0016; C22C 45/00
USPC 403/52; 228/245; 403/272

(57) ABSTRACT

Provided in one embodiment is a method of joining one or more articles together using pressurized fluid to deform a bulk-solidifying amorphous alloy material and form a mechanical interlock between the respective surfaces joined together.

### RELATED APPLICATION

This application is related to U.S. patent application Ser. No. 12/984,433, filed Jan. 4, 2001, and U.S. patent application Ser. No. 12/984,440, filed Jan. 4, 2011, both of which are incorporated herein by reference in their entireties.

### FIELD OF INVENTION

This invention relates to methods for joining using bulk solidifying amorphous alloy sheets using a pressurized fluid to form a joint and to components having such a joint.

### BACKGROUND

Bulk-solidifying amorphous alloys have been made in a variety of metal systems. They are generally prepared by quenching from above the melting temperature to the ambient temperature. Generally, high cooling rates on the order of 10⁵° C./sec, are needed to achieve an amorphous structure. The lowest rate by which a bulk solidifying alloy can be cooled to avoid crystallization, thereby achieving and maintaining the amorphous structure during cooling, is referred to as the “critical cooling rate” for the alloy. In order to achieve a cooling rate higher than the critical cooling rate, heat has to be extracted from the sample. Thus, the thickness of articles made from amorphous alloys often becomes a limiting dimension, which is generally referred to as the “critical (casting) thickness.” A critical casting thickness can be obtained by heat-flow calculations, taking into account the critical cooling rate.

Until the early nineties, the processability of amorphous alloys was quite limited, and amorphous alloys were readily available only in powder form or in very thin foils or strips with a critical casting thickness of less than 100 micrometers. A new class of amorphous alloys based mostly on Zr and Ti alloy systems was developed in the nineties, and since then more amorphous alloy systems based on different elements have been developed. These families of alloys have much lower critical cooling rates of less than 10³° C./sec, and thus these articles have much larger critical casting thicknesses than their previous counterparts. However, little has been shown regarding how to utilize and/or shape these alloy systems into structural components, such as those of consumer electronic devices. Thus, a need exists to develop methods of utilizing amorphous alloys and shaping them into structural components that can be useful to join two articles together.

U.S. Patent Application Publication No. 2011/0079940 discloses methods for blow molding bulk metallic glass in its supercooled liquid state that avoids the frictional stick forces experienced in conventional molding techniques by expanding the pre-shaped parison of bulk metallic glass such that substantially all of the lateral strain required to form the final article is accomplished prior to the outer surface contacting the surface of the shaping apparatus. This application discloses the use of air or inert gas to form the bulk metallic glass into the mold.

U.S. Pat. No. 7,947,134 discloses methods and compositions for metal-to-metal or material-to-material joining using bulk metallic glasses (BMG). The method relies on the mechanical properties of BMG and/or the softening behavior of metallic glasses in the undercooled liquid region of temperature-time process space, and is said to enable joining of a variety of materials at lower temperatures than typical ranges used for soldering, brazing, or welding. The materials are joined together by disposing a BMG composition between the components to be joined, heating the BMG, and pressing the components together.

### SUMMARY

A proposed solution according to embodiments herein for methods of joining articles together is to use bulk-solidifying amorphous alloys as the material joining the articles together, and to apply fluid pressure on the alloy to deform the alloy into a shape the sufficiently binds the articles to one another. In accordance with these and other embodiments, there is provided a method of joining articles to one another that includes providing at least a first and second article with a space defined therebetween, each first and second article having at least a first surface and at least a second surface on a side of the article opposite the first surface, positioning a bulk-solidifying amorphous alloy material adjacent at least one of the first and second surfaces of the first article and adjacent at least one surface of the second article, thereby positioning the bulk-solidifying amorphous alloy at least partially between the first and second article. The method further includes applying fluid pressure against the bulk-solidifying amorphous alloy to force at least a portion of the alloy between the first and second articles so that at least a portion of the alloy is positioned adjacent both first and second surfaces of the first and second article.

In accordance with an additional embodiment, there is provided a method of joining articles to one another that includes providing at least a first and second article with a space defined therebetween, each first and second article having at least a first surface and at least a second surface on a side of the article opposite the first surface, positioning a bulk-solidifying amorphous alloy material adjacent at least one of the first and second surfaces of the first article and adjacent at least one surface of the second article, thereby positioning the bulk-solidifying amorphous alloy at least partially between the first and second article. The method further includes applying fluid pressure against the bulk-solidifying amorphous alloy to force at least a portion of the alloy between the first and second articles, and applying a force opposing the direction of the fluid pressure force to position the bulk-solidifying amorphous alloy adjacent at least a portion of the other surface of the first and second article.

### BRIEF DESCRIPTION OF THE DRAWINGS

FIG. 1 provides a temperature-viscosity diagram of an exemplary bulk solidifying amorphous alloy.

FIG. 2 provides a schematic of a time-temperature-transformation (TTT) diagram for an exemplary bulk solidifying amorphous alloy.

FIG. 3 provides a view of an exemplary portion of a method of joining two articles in accordance with a preferred embodiment.

FIG. 4 provides a view of a continuation of the method shown in FIG. 3.

FIG. 5 provides a view of a continuation of the method shown in FIG. 4.

FIG. 6 provides a view of an optional final portion of particularly preferred embodiment.

FIG. 7 provides a view of a fully formed mechanical interlock, with no space between the articles being joined.

FIG. 8 provides a cross-sectional view of two articles joined together in accordance with a particularly preferred embodiment.

### DETAILED DESCRIPTION

All publications, patents, and patent applications cited in this Specification are hereby incorporated by reference in their entirety.

The articles “a” and “an” are used herein to refer to one or to more than one (i.e., to at least one) of the grammatical object of the article. By way of example, “a polymer resin” means one polymer resin or more than one polymer resin. Any ranges cited herein are inclusive. The terms “substantially” and “about” used throughout this Specification are used to describe and account for small fluctuations. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

Bulk-solidifying amorphous alloys, or bulk metallic glasses (“BMG”), are a recently developed class of metallic materials. These alloys may be solidified and cooled at relatively slow rates, and they retain the amorphous, non-crystalline (i.e., glassy) state at room temperature. Amorphous alloys have many superior properties than their crystalline counterparts. However, if the cooling rate is not sufficiently high, crystals may form inside the alloy during cooling, so that the benefits of the amorphous state can be lost. For example, one challenge with the fabrication of bulk amorphous alloy parts is partial crystallization of the parts due to either slow cooling or impurities in the raw alloy material. As a high degree of amorphicity (and, conversely, a low degree of crystallinity) is desirable in BMG parts, there is a need to develop methods for casting BMG parts having controlled amount of amorphicity.

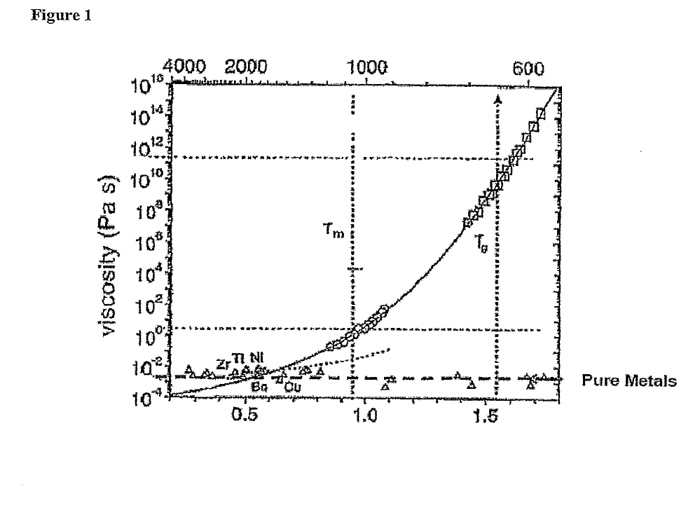

FIG. 1 (obtained from U.S. Pat. No. 7,575,040) shows a viscosity-temperature graph of an exemplary bulk solidifying amorphous alloy, from the VIT-001 series of Zr—Ti—Ni—Cu—Be family manufactured by Liquidmetal Technology. It should be noted that there is no clear liquid/solid transformation for a bulk solidifying amorphous metal during the formation of an amorphous solid. The molten alloy becomes more and more viscous with increasing undercooling until it approaches solid form around the glass transition temperature. Accordingly, the temperature of solidification front for bulk solidifying amorphous alloys can be around glass transition temperature, where the alloy will practically act as a solid for the purposes of pulling out the quenched amorphous sheet product.

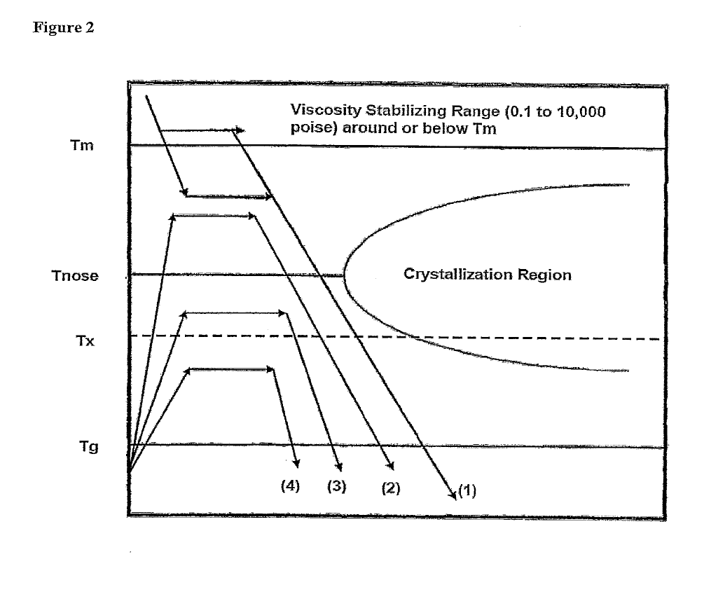

FIG. 2 (obtained from U.S. Pat. No. 7,575,040) shows the time-temperature-transformation (TTT) cooling curve of an exemplary bulk solidifying amorphous alloy, or TTT diagram. Bulk-solidifying amorphous metals do not experience a liquid/solid crystallization transformation upon cooling, as with conventional metals. Instead, the highly fluid, non crystalline form of the metal found at high temperatures (near a “melting temperature” Tm) becomes more viscous as the temperature is reduced (near to the glass transition temperature Tg), eventually taking on the outward physical properties of a conventional solid.

Even though there is no liquid/crystallization transformation for a bulk solidifying amorphous metal, a “melting temperature” Tm may be defined as the thermodynamic liquidus temperature of the corresponding crystalline phase. Under this regime, the viscosity of bulk-solidifying amorphous alloys at the melting temperature could lie in the range of about 0.1 poise to about 10,000 poise, and even sometimes under 0.01 poise. A lower viscosity at the “melting temperature” would provide faster and complete filling of intricate portions of the shell/mold with a bulk solidifying amorphous metal for forming the BMG parts. Furthermore, the cooling rate of the molten metal to form a BMG part has to such that the time-temperature profile during cooling does not traverse through the nose-shaped region bounding the crystallized region in the TTT diagram of FIG. 2. In FIG. 2, Tnose is the critical crystallization temperature Tx where crystallization is most rapid and occurs in the shortest time scale.

The supercooled liquid region, the temperature region between Tg and Tx is a manifestation of the extraordinary stability against crystallization of bulk solidification alloys. In this temperature region the bulk solidifying alloy can exist as a high viscous liquid. The viscosity of the bulk solidifying alloy in the supercooled liquid region can vary between 1012 Pa s at the glass transition temperature down to 105 Pa s at the crystallization temperature, the high temperature limit of the supercooled liquid region. Liquids with such viscosities can undergo substantial plastic strain under an applied pressure. The embodiments herein make use of the large plastic formability in the supercooled liquid region as a forming and separating method.

One needs to clarify something about Tx. Technically, the nose-shaped curve shown in the TTT diagram describes Tx as a function of temperature and time. Thus, regardless of the trajectory that one takes while heating or cooling a metal alloy, when one hits the TIT curve, one has reached Tx. In FIG. 2, Tx is shown as a dashed line as Tx can vary from close to Tm to close to Tg.

The schematic TTT diagram of FIG. 2 shows processing methods of die casting from at or above Tm to below Tg without the time-temperature trajectory (shown as (1) as an example trajectory) hitting the TTT curve. During die casting, the forming takes place substeantially simultaneously with fast cooling to avoid the trajectory hitting the ITT curve. The processing methods for superplastic forming (SPF) from at or below Tg to below Tm without the time-temperature trajectory (shown as (2), (3) and (4) as example trajectories) hitting the TTT curve. In SPF, the amorphous BMG is reheated into the supercooled liquid region where the available processing window could be much larger than die casting, resulting in better controllability of the process. The SPF process does not require fast cooling to avoid crystallization during cooling. Also, as shown by example trajectories (2), (3) and (4), the SPF can be carried out with the highest temperature during SPF being above Tnose or below Tnose, up to about Tm. If one heats up a piece of amorphous alloy but manages to avoid hitting the TTT curve, you have heated “between Tg and Tm”, but one would have not reached Tx.

Typical differential scanning calorimeter (DSC) heating curves of bulk-solidifying amorphous alloys taken at a heating rate of 20 C/min describe, for the most part, a particular trajectory across the TIT data where one would likely see a Tg at a certain temperature, a Tx when the DSC heating ramp crosses the TTT crystallization onset, and eventually melting peaks when the same trajectory crosses the temperature range for melting. If one heats a bulk-solidifying amorphous alloy at a rapid heating rate as shown by the ramp up portion of trajectories (2), (3) and (4) in FIG. 2, then one could avoid the TTT curve entirely, and the DSC data would show a glass transition but no Tx upon heating. Another way to think about it is trajectories (2), (3) and (4) can fall anywhere in temperature between the nose of the TTT curve (and even above it) and the Tg line, as long as it does not hit the crystallization curve. That just means that the horizontal plateau in trajectories might get much shorter as one increases the processing temperature.

### Phase

The term “phase” herein can refer to one that can be found in a thermodynamic phase diagram. A phase is a region of space (e.g., a thermodynamic system) throughout which all physical properties of a material are essentially uniform. Examples of physical properties include density, index of refraction, chemical composition and lattice periodicity. A simple description of a phase is a region of material that is chemically uniform, physically distinct, and/or mechanically separable. For example, in a system consisting of ice and water in a glass jar, the ice cubes are one phase, the water is a second phase, and the humid air over the water is a third phase. The glass of the jar is another separate phase. A phase can refer to a solid solution, which can be a binary, tertiary, quaternary, or more, solution, or a compound, such as an intermetallic compound. As another example, an amorphous phase is distinct from a crystalline phase.

### Metal, Transition Metal, and Non-Metal

The term “metal” refers to an electropositive chemical element. The term “element” in this Specification refers generally to an element that can be found in a Periodic Table. Physically, a metal atom in the ground state contains a partially filled band with an empty state close to an occupied state. The term “transition metal” is any of the metallic elements within Groups 3 to 12 in the Periodic Table that have an incomplete inner electron shell and that serve as transitional links between the most and the least electropositive in a series of elements. Transition metals are characterized by multiple valences, colored compounds, and the ability to form stable complex ions. The term “nonmetal” refers to a chemical element that does not have the capacity to lose electrons and form a positive ion.

Depending on the application, any suitable nonmetal elements, or their combinations, can be used. The alloy (or “alloy composition”) can comprise multiple nonmetal elements, such as at least two, at least three, at least four, or more, nonmetal elements. A nonmetal element can be any element that is found in Groups 13-17 in the Periodic Table. For example, a nonmetal element can be any one of F, Cl, Br, I, At, O, S, Se, Te, Po, N, P, As, Sb, Bi, C, Si, Ge, Sn, Pb, and B. Occasionally, a nonmetal element can also refer to certain metalloids (e.g., B, Si, Ge, As, Sb, Te, and Po) in Groups 13-17. In one embodiment, the nonmetal elements can include B, Si, C, P, or combinations thereof. Accordingly, for example, the alloy can comprise a boride, a carbide, or both.

A transition metal element can be any of scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, gold, mercury, rutherfordium, dubnium, seaborgium, bohrium, hassium, meitnerium, ununnilium, unununium, and ununbium. In one embodiment, a BMG containing a transition metal element can have at least one of Sc, Y, La, Ac, Ti, Zr, Hf, V, Nb, Ta, Cr, Mo, W, Mn, Tc, Re, Fe, Ru, Os, Co, Rh, Ir, Ni, Pd, Pt, Cu, Ag, Au, Zn, Cd, and Hg. Depending on the application, any suitable transitional metal elements, or their combinations, can be used. The alloy composition can comprise multiple transitional metal elements, such as at least two, at least three, at least four, or more, transitional metal elements.

The presently described alloy or alloy “sample” or “specimen” alloy can have any shape or size. For example, the alloy can have a shape of a particulate, which can have a shape such as spherical, ellipsoid, wire-like, rod-like, sheet-like, flake-like, or an irregular shape. The particulate can have any size. For example, it can have an average diameter of between about 1 micron and about 100 microns, such as between about 5 microns and about 80 microns, such as between about 10 microns and about 60 microns, such as between about 15 microns and about 50 microns, such as between about 15 microns and about 45 microns, such as between about 20 microns and about 40 microns, such as between about 25 microns and about 35 microns. For example, in one embodiment, the average diameter of the particulate is between about 25 microns and about 44 microns. In some embodiments, smaller particulates, such as those in the nanometer range, or larger particulates, such as those bigger than 100 microns, can be used.

The alloy sample or specimen can also be of a much larger dimension. For example, it can be a bulk structural component, such as an ingot, housing/casing of an electronic device or even a portion of a structural component that has dimensions in the millimeter, centimeter, or meter range.

### Solid Solution

The term “solid solution” refers to a solid form of a solution. The term “solution” refers to a mixture of two or more substances, which may be solids, liquids, gases, or a combination of these. The mixture can be homogeneous or heterogeneous. The term “mixture” is a composition of two or more substances that are combined with each other and are generally capable of being separated. Generally, the two or more substances are not chemically combined with each other.

### Alloy

In some embodiments, the alloy composition described herein can be fully alloyed. In one embodiment, an “alloy” refers to a homogeneous mixture or solid solution of two or more metals, the atoms of one replacing or occupying interstitial positions between the atoms of the other; for example, brass is an alloy of zinc and copper. An alloy, in contrast to a composite, can refer to a partial or complete solid solution of one or more elements in a metal matrix, such as one or more compounds in a metallic matrix. The term alloy herein can refer to both a complete solid solution alloy that can give single solid phase microstructure and a partial solution that can give two or more phases. An alloy composition described herein can refer to one comprising an alloy or one comprising an alloy-containing composite.

Thus, a fully alloyed alloy can have a homogenous distribution of the constituents, be it a solid solution phase, a compound phase, or both. The term “fully alloyed” used herein can account for minor variations within the error tolerance. For example, it can refer to at least 90% alloyed, such as at least 95% alloyed, such as at least 99% alloyed, such as at least 99.5% alloyed, such as at least 99.9% alloyed. The percentage herein can refer to either volume percent or weight percentage, depending on the context. These percentages can be balanced by impurities, which can be in terms of composition or phases that are not a part of the alloy.

### Amorphous or Non-Crystalline Solid

An “amorphous” or “non-crystalline solid” is a solid that lacks lattice periodicity, which is characteristic of a crystal. As used herein, an “amorphous solid” includes “glass” which is an amorphous solid that softens and transforms into a liquid-like state upon heating through the glass transition. Generally, amorphous materials lack the long-range order characteristic of a crystal, though they can possess some short-range order at the atomic length scale due to the nature of chemical bonding. The distinction between amorphous solids and crystalline solids can be made based on lattice periodicity as determined by structural characterization techniques such as x-ray diffraction and transmission electron microscopy.

The terms “order” and “disorder” designate the presence or absence of some symmetry or correlation in a many-particle system. The terms “long-range order” and “short-range order” distinguish order in materials based on length scales.

The strictest form of order in a solid is lattice periodicity: a certain pattern (the arrangement of atoms in a unit cell) is repeated again and again to form a translationally invariant tiling of space. This is the defining property of a crystal. Possible symmetries have been classified in 14 Bravais lattices and 230 space groups.

Lattice periodicity implies long-range order. If only one unit cell is known, then by virtue of the translational symmetry it is possible to accurately predict all atomic positions at arbitrary distances. The converse is generally true, except, for example, in quasi-crystals that have perfectly deterministic tilings but do not possess lattice periodicity.

Long-range order characterizes physical systems in which remote portions of the same sample exhibit correlated behavior. This can be expressed as a correlation function, namely the spin-spin correlation function:

In the above function, s is the spin quantum number and x is the distance function within the particular system. This function is equal to unity when x=x′ and decreases as the distance |x−x′| increases. Typically, it decays exponentially to zero at large distances, and the system is considered to be disordered. If, however, the correlation function decays to a constant value at large |x−x′|, then the system can be said to possess long-range order. If it decays to zero as a power of the distance, then it can be called quasi-long-range order. Note that what constitutes a large value of |x−x′| is relative.

A system can be said to present quenched disorder when some parameters defining its behavior are random variables that do not evolve with time (i.e., they are quenched or frozen)—e.g., spin glasses. It is opposite to annealed disorder, where the random variables are allowed to evolve themselves. Embodiments herein include systems comprising quenched disorder.

The alloy described herein can be crystalline, partially crystalline, amorphous, or substantially amorphous. For example, the alloy sample/specimen can include at least some crystallinity, with grains/crystals having sizes in the nanometer and/or micrometer ranges. Alternatively, the alloy can be substantially amorphous, such as fully amorphous. In one embodiment, the alloy composition is at least substantially not amorphous, such as being substantially crystalline, such as being entirely crystalline.

In one embodiment, the presence of a crystal or a plurality of crystals in an otherwise amorphous alloy can be construed as a “crystalline phase” therein. The degree of crystallinity (or “crystallinity” for short in some embodiments) of an alloy can refer to the amount of the crystalline phase present in the alloy. The degree can refer to, for example, a fraction of crystals present in the alloy. The fraction can refer to volume fraction or weight fraction, depending on the context. A measure of how “amorphous” an amorphous alloy is can be amorphicity. Amorphicity can be measured in terms of a degree of crystallinity. For example, in one embodiment, an alloy having a low degree of crystallinity can be said to have a high degree of amorphicity. In one embodiment, for example, an alloy having 60 vol % crystalline phase can have a 40 vol % amorphous phase.

### Amorphous Alloy or Amorphous Metal

An “amorphous alloy” is an alloy having an amorphous content of more than 50% by volume, preferably more than 90% by volume of amorphous content, more preferably more than 95% by volume of amorphous content, and most preferably more than 99% to almost 100% by volume of amorphous content. Note that, as described above, an alloy high in amorphicity is equivalently low in degree of crystallinity. An “amorphous metal” is an amorphous metal material with a disordered atomic-scale structure. In contrast to most metals, which are crystalline and therefore have a highly ordered arrangement of atoms, amorphous alloys are non-crystalline. Materials in which such a disordered structure is produced directly from the liquid state during cooling are sometimes referred to as “glasses.” Accordingly, amorphous metals are commonly referred to as “metallic glasses” or “glassy metals.” In one embodiment, a bulk metallic glass (“BMG”) can refer to an alloy, of which the microstructure is at least partially amorphous. However, there are several ways besides extremely rapid cooling to produce amorphous metals, including physical vapor deposition, solid-state reaction, ion irradiation, melt spinning, and mechanical alloying. Amorphous alloys can be a single class of materials, regardless of how they are prepared.

Amorphous metals can be produced through a variety of quick-cooling methods. For instance, amorphous metals can be produced by sputtering molten metal onto a spinning metal disk. The rapid cooling, on the order of millions of degrees a second, can be too fast for crystals to form, and the material is thus “locked in” a glassy state. Also, amorphous metals/alloys can be produced with critical cooling rates low enough to allow formation of amorphous structures in thick layers—e.g., bulk metallic glasses.

The terms “bulk metallic glass” (“BMG”), bulk amorphous alloy (“BAA”), and bulk solidifying amorphous alloy are used interchangeably herein. They refer to amorphous alloys having the smallest dimension at least in the millimeter range. For example, the dimension can be at least about 0.5 mm, such as at least about 1 mm, such as at least about 2 mm, such as at least about 4 mm, such as at least about 5 mm, such as at least about 6 mm, such as at least about 8 mm, such as at least about 10 mm, such as at least about 12 mm. Depending on the geometry, the dimension can refer to the diameter, radius, thickness, width, length, etc. A BMG can also be a metallic glass having at least one dimension in the centimeter range, such as at least about 1.0 cm, such as at least about 2.0 cm, such as at least about 5.0 cm, such as at least about 10.0 cm. In some embodiments, a BMG can have at least one dimension at least in the meter range. A BMG can take any of the shapes or forms described above, as related to a metallic glass. Accordingly, a BMG described herein in some embodiments can be different from a thin film made by a conventional deposition technique in one important aspect—the former can be of a much larger dimension than the latter.

Amorphous metals can be an alloy rather than a pure metal. The alloys may contain atoms of significantly different sizes, leading to low free volume (and therefore having viscosity up to orders of magnitude higher than other metals and alloys) in a molten state. The viscosity prevents the atoms from moving enough to form an ordered lattice. The material structure may result in low shrinkage during cooling and resistance to plastic deformation. The absence of grain boundaries, the weak spots of crystalline materials in some cases, may, for example, lead to better resistance to wear and corrosion. In one embodiment, amorphous metals, while technically glasses, may also be much tougher and less brittle than oxide glasses and ceramics.

Thermal conductivity of amorphous materials may be lower than that of their crystalline counterparts. To achieve formation of an amorphous structure even during slower cooling, the alloy may be made of three or more components, leading to complex crystal units with higher potential energy and lower probability of formation. The formation of amorphous alloy can depend on several factors: the composition of the components of the alloy; the atomic radius of the components (preferably with a significant difference of over 12% to achieve high packing density and low free volume); and the negative heat of mixing the combination of components, inhibiting crystal nucleation and prolonging the time the molten metal stays in a supercooled state. However, as the formation of an amorphous alloy is based on many different variables, it can be difficult to make a prior determination of whether an alloy composition would form an amorphous alloy.

Amorphous alloys, for example, of boron, silicon, phosphorus, and other glass formers with magnetic metals (iron, cobalt, nickel) may be magnetic, with low coercivity and high electrical resistance. The high resistance leads to low losses by eddy currents when subjected to alternating magnetic fields, a property useful, for example, as transformer magnetic cores.

Amorphous alloys may have a variety of potentially useful properties. In particular, they tend to be stronger than crystalline alloys of similar chemical composition, and they can sustain larger reversible (“elastic”) deformations than crystalline alloys. Amorphous metals derive their strength directly from their non-crystalline structure, which can have none of the defects (such as dislocations) that limit the strength of crystalline alloys. For example, one modern amorphous metal, known as Vitreloy™, has a tensile strength that is almost twice that of high-grade titanium. In some embodiments, metallic glasses at room temperature are not ductile and tend to fail suddenly when loaded in tension, which limits the material applicability in reliability-critical applications, as the impending failure is not evident. Therefore, to overcome this challenge, metal matrix composite materials having a metallic glass matrix containing dendritic particles or fibers of a ductile crystalline metal can be used. Alternatively, a BMG low in element(s) that tend to cause embitterment (e.g., Ni) can be used. For example, a Ni-free BMG can be used to improve the ductility of the BMG.

Another useful property of bulk amorphous alloys is that they can be true glasses; in other words, they can soften and flow upon heating. This can allow for easy processing, such as by injection molding, in much the same way as polymers. As a result, amorphous alloys can be used for making sports equipment, medical devices, electronic components and equipment, and thin films. Thin films of amorphous metals can be deposited as protective coatings via a high velocity oxygen fuel technique.

A material can have an amorphous phase, a crystalline phase, or both. The amorphous and crystalline phases can have the same chemical composition and differ only in the microstructure—i.e., one amorphous and the other crystalline. Microstructure in one embodiment refers to the structure of a material as revealed by a microscope at 25× magnification or higher. Alternatively, the two phases can have different chemical compositions and microstructures. For example, a composition can be partially amorphous, substantially amorphous, or completely amorphous.

As described above, the degree of amorphicity (and conversely the degree of crystallinity) can be measured by fraction of crystals present in the alloy. The degree can refer to volume fraction of weight fraction of the crystalline phase present in the alloy. A partially amorphous composition can refer to a composition of at least about 5 vol % of which is of an amorphous phase, such as at least about 10 vol %, such as at least about 20 vol %, such as at least about 40 vol %, such as at least about 60 vol %, such as at least about 80 vol %, such as at least about 90 vol %. The terms “substantially” and “about” have been defined elsewhere in this application. Accordingly, a composition that is at least substantially amorphous can refer to one of which at least about 90 vol % is amorphous, such as at least about 95 vol %, such as at least about 98 vol %, such as at least about 99 vol %, such as at least about 99.5 vol %, such as at least about 99.8 vol %, such as at least about 99.9 vol %. In one embodiment, a substantially amorphous composition can have some incidental, insignificant amount of crystalline phase present therein.

In one embodiment, an amorphous alloy composition can be homogeneous with respect to the amorphous phase. A substance that is uniform in composition is homogeneous. This is in contrast to a substance that is heterogeneous. The term “composition” refers to the chemical composition and/or microstructure in the substance. A substance is homogeneous when a volume of the substance is divided in half and both halves have substantially the same composition. For example, a particulate suspension is homogeneous when a volume of the particulate suspension is divided in half and both halves have substantially the same volume of particles. However, it might be possible to see the individual particles under a microscope. Another example of a homogeneous substance is air where different ingredients therein are equally suspended, though the particles, gases and liquids in air can be analyzed separately or separated from air.

A composition that is homogeneous with respect to an amorphous alloy can refer to one having an amorphous phase substantially uniformly distributed throughout its microstructure. In other words, the composition macroscopically comprises a substantially uniformly distributed amorphous alloy throughout the composition. In an alternative embodiment, the composition can be of a composite, having an amorphous phase having therein a non-amorphous phase. The non-amorphous phase can be a crystal or a plurality of crystals. The crystals can be in the form of particulates of any shape, such as spherical, ellipsoid, wire-like, rod-like, sheet-like, flake-like, or an irregular shape. In one embodiment, it can have a dendritic form. For example, an at least partially amorphous composite composition can have a crystalline phase in the shape of dendrites dispersed in an amorphous phase matrix; the dispersion can be uniform or non-uniform, and the amorphous phase and the crystalline phase can have the same or a different chemical composition. In one embodiment, they have substantially the same chemical composition. In another embodiment, the crystalline phase can be more ductile than the BMG phase.

The methods described herein can be applicable to any type of amorphous alloy. Similarly, the amorphous alloy described herein as a constituent of a composition or article can be of any type. The amorphous alloy can comprise the element Zr, Hf, Ti, Cu, Ni, Pt, Pd, Fe, Mg, Au, La, Ag, Al, Mo, Nb, Be, or combinations thereof. Namely, the alloy can include any combination of these elements in its chemical formula or chemical composition. The elements can be present at different weight or volume percentages. For example, an iron “based” alloy can refer to an alloy having a non-insignificant weight percentage of iron present therein, the weight percent can be, for example, at least about 20 wt %, such as at least about 40 wt %, such as at least about 50 wt %, such as at least about 60 wt %, such as at least about 80 wt %. Alternatively, in one embodiment, the above-described percentages can be volume percentages, instead of weight percentages. Accordingly, an amorphous alloy can be zirconium-based, titanium-based, platinum-based, palladium-based, gold-based, silver-based, copper-based, iron-based, nickel-based, aluminum-based, molybdenum-based, and the like. The alloy can also be free of any of the aforementioned elements to suit a particular purpose. For example, in some embodiments, the alloy, or the composition including the alloy, can be substantially free of nickel, aluminum, titanium, beryllium, or combinations thereof. In one embodiment, the alloy or the composite is completely free of nickel, aluminum, titanium, beryllium, or combinations thereof.

For example, the amorphous alloy can have the formula (Zr, Ti)a(Ni, Cu, Fe)b(Be, Al, Si, B)c, wherein a, b, and c each represents a weight or atomic percentage. In one embodiment, a is in the range of from 30 to 75, b is in the range of from 5 to 60, and c is in the range of from 0 to 50 in atomic percentages. Alternatively, the amorphous alloy can have the formula (Zr, Ti)a(Ni, Cu)b(Be)c, wherein a, b, and c each represents a weight or atomic percentage. In one embodiment, a is in the range of from 40 to 75, b is in the range of from 5 to 50, and c is in the range of from 5 to 50 in atomic percentages. The alloy can also have the formula (Zr, Ti)a(Ni, Cu)b(Be)c, wherein a, b, and c each represents a weight or atomic percentage. In one embodiment, a is in the range of from 45 to 65, b is in the range of from 7.5 to 35, and c is in the range of from 10 to 37.5 in atomic percentages. Alternatively, the alloy can have the formula (Zr)a(Nb, Ti)b(Ni, Cu)c(Al)d, wherein a, b, c, and d each represents a weight or atomic percentage. In one embodiment, a is in the range of from 45 to 65, b is in the range of from 0 to 10, c is in the range of from 20 to 40 and d is in the range of from 7.5 to 15 in atomic percentages. One exemplary embodiment of the aforedescribed alloy system is a Zr—Ti—Ni—Cu—Be based amorphous alloy under the trade name Vitreloy™, such as Vitreloy-1 and Vitreloy-101, as fabricated by Liquidmetal Technologies, CA, USA. Some examples of amorphous alloys of the different systems are provided in Table 1.

The amorphous alloys can also be ferrous alloys, such as (Fe, Ni, Co) based alloys. Examples of such compositions are disclosed in U.S. Pat. Nos. 6,325,868; 5,288,344; 5,368,659; 5,618,359; and U.S. Pat. No. 5,735,975, Inoue et al., Appl. Phys. Lett., Volume 71, p 464 (1997), Shen et al., Mater. Trans., JIM, Volume 42, p 2136 (2001), and Japanese Patent Application No. 200126277 (Pub. No. 2001303218 A). One exemplary composition is Fe72Al5Ga2P11C6B4. Another example is Fe72Al7Zr10Mo5W2B15. Another iron-based alloy system that can be used in the coating herein is disclosed in U.S. Patent Application Publication No. 2010/0084052, wherein the amorphous metal contains, for example, manganese (1 to 3 atomic %), yttrium (0.1 to 10 atomic %), and silicon (0.3 to 3.1 atomic %) in the range of composition given in parentheses; and that contains the following elements in the specified range of composition given in parentheses: chromium (15 to 20 atomic %), molybdenum (2 to 15 atomic %), tungsten (1 to 3 atomic %), boron (5 to 16 atomic %), carbon (3 to 16 atomic %), and the balance iron.

The aforedescribed amorphous alloy systems can further include additional elements, such as additional transition metal elements, including Nb, Cr, V, and Co. The additional elements can be present at less than or equal to about 30 wt %, such as less than or equal to about 20 wt %, such as less than or equal to about 10 wt %, such as less than or equal to about 5 wt %. In one embodiment, the additional, optional element is at least one of cobalt, manganese, zirconium, tantalum, niobium, tungsten, yttrium, titanium, vanadium and hafnium to form carbides and further improve wear and corrosion resistance. Further optional elements may include phosphorous, germanium and arsenic, totaling up to about 2%, and preferably less than 1%, to reduce melting point. Otherwise incidental impurities should be less than about 2% and preferably 0.5%.

TABLE 1
Exemplary amorphous alloy compositions

| Alloy | Atm % | Atm % | Atm % | Atm % | Atm % | Atm % |
|---|---|---|---|---|---|---|
| 1 | Zr | Ti | Cu | Ni | Be | |
| | 41.20% | 13.80% | 12.50% | 10.00% | 22.50% | |
| 2 | Zr | Ti | Cu | Ni | Be | |
| | 44.00% | 11.00% | 10.00% | 10.00% | 25.00% | |
| 3 | Zr | Ti | Cu | Ni | Nb | Be |
| | 56.25% | 11.25% | 6.88% | 5.63% | 7.50% | 12.50% |
| 4 | Zr | Ti | Cu | Ni | Al | Be |
| | 64.75% | 5.60% | 14.90% | 11.15% | 2.60% | 1.00% |
| 5 | Zr | Ti | Cu | Ni | Al | |
| | 52.50% | 5.00% | 17.90% | 14.60% | 10.00% | |
| 6 | Zr | Nb | Cu | Ni | Al | |
| | 57.00% | 5.00% | 15.40% | 12.60% | 10.00% | |
| 7 | Zr | Cu | Ni | Al | Sn | |
| | 50.75% | 36.23% | 4.03% | 9.00% | 0.50% | |
| 8 | Zr | Ti | Cu | Ni | Be | |
| | 46.75% | 8.25% | 7.50% | 10.00% | 27.50% | |
| 9 | Zr | Ti | Ni | Be | | |
| | 21.67% | 43.33% | 7.50% | 27.50% | | |
| 10 | Zr | Ti | Cu | Be | | |
| | 35.00% | 30.00% | 7.50% | 27.50% | | |
| 11 | Zr | Ti | Co | Be | | |
| | 35.00% | 30.00% | 6.00% | 29.00% | | |
| 12 | Au | Ag | Pd | Cu | Si | |
| | 49.00% | 5.50% | 2.30% | 26.90% | 16.30% | |
| 13 | Au | Ag | Pd | Cu | Si | |
| | 50.90% | 3.00% | 2.30% | 27.80% | 16.00% | |
| 14 | Pt | Cu | Ni | P | | |
| | 57.50% | 14.70% | 5.30% | 22.50% | | |
| 15 | Zr | Ti | Nb | Cu | Be | |
| | 36.60% | 31.40% | 7.00% | 5.90% | 19.10% | |
| 16 | Zr | Ti | Nb | Cu | Be | |
| | 38.30% | 32.90% | 7.30% | 6.20% | 15.30% | |
| 17 | Zr | Ti | Nb | Cu | Be | |
| | 39.60% | 33.90% | 7.60% | 6.40% | 12.50% | |
| 18 | Cu | Ti | Zr | Ni | | |
| | 47.00% | 34.00% | 11.00% | 8.00% | | |
| 19 | Zr | Co | Al | | | |
| | 55.00% | 25.00% | 20.00% | | | |

In some embodiments, a composition having an amorphous alloy can include a small amount of impurities. The impurity elements can be intentionally added to modify the properties of the composition, such as improving the mechanical properties (e.g., hardness, strength, fracture mechanism, etc.) and/or improving the corrosion resistance. Alternatively, the impurities can be present as inevitable, incidental impurities, such as those obtained as a byproduct of processing and manufacturing. The impurities can be less than or equal to about 10 wt %, such as about 5 wt %, such as about 2 wt %, such as about 1 wt %, such as about 0.5 wt %, such as about 0.1 wt %. In some embodiments, these percentages can be volume percentages instead of weight percentages. In one embodiment, the alloy sample/composition consists essentially of the amorphous alloy (with only a small incidental amount of impurities). In another embodiment, the composition includes the amorphous alloy (with no observable trace of impurities).

In one embodiment, the final parts exceeded the critical casting thickness of the bulk solidifying amorphous alloys.

In embodiments herein, the existence of a supercooled liquid region in which the bulk-solidifying amorphous alloy can exist as a high viscous liquid allows for superplastic forming. Large plastic deformations can be obtained. The ability to undergo large plastic deformation in the supercooled liquid region is used for the forming and/or cutting process. As oppose to solids, the liquid bulk solidifying alloy deforms locally which drastically lowers the required energy for cutting and forming. The ease of cutting and forming depends on the temperature of the alloy, the mold, and the cutting tool. As higher is the temperature, the lower is the viscosity, and consequently easier is the cutting and forming.

Embodiments herein can utilize a thermoplastic-forming process with amorphous alloys carried out between Tg and Tx, for example. Herein, Tx and Tg are determined from standard DSC measurements at typical heating rates (e.g. 20° C./min) as the onset of crystallization temperature and the onset of glass transition temperature.

The amorphous alloy components can have the critical casting thickness and the final part can have thickness that is thicker than the critical casting thickness. Moreover, the time and temperature of the heating and shaping operation is selected such that the elastic strain limit of the amorphous alloy could be substantially preserved to be not less than 1.0%, and preferably not being less than 1.5%. In the context of the embodiments herein, temperatures around glass transition means the forming temperatures can be below glass transition, at or around glass transition, and above glass transition temperature, but preferably at temperatures below the crystallization temperature Tx. The cooling step is carried out at rates similar to the heating rates at the heating step, and preferably at rates greater than the heating rates at the heating step. The cooling step is also achieved preferably while the forming and shaping loads are still maintained.

### Electronic Devices

The embodiments herein can be valuable in the fabrication of electronic devices using a BMG. An electronic device herein can refer to any electronic device known in the art. For example, it can be a telephone, such as a cell phone, and a land-line phone, or any communication device, such as a smart phone, including, for example an iPhone™, and an electronic email sending/receiving device. It can be a part of a display, such as a digital display, a TV monitor, an electronic-book reader, a portable web-browser (e.g., iPad™), and a computer monitor. It can also be an entertainment device, including a portable DVD player, conventional DVD player, Blue-Ray disk player, video game console, music player, such as a portable music player (e.g., iPod™), etc. It can also be a part of a device that provides control, such as controlling the streaming of images, videos, sounds (e.g., Apple TV™), or it can be a remote control for an electronic device. It can be a part of a computer or its accessories, such as the hard drive tower housing or casing, laptop housing, laptop keyboard, laptop track pad, desktop keyboard, mouse, and speaker. The article can also be applied to a device such as a watch or a clock.

### Embodiments

The preferred embodiments include a method of joining articles to one another that includes providing at least a first and second article with a space defined therebetween, each first and second article having at least a first surface and at least a second surface on a side of the article opposite the first surface, positioning a bulk-solidifying amorphous alloy material adjacent at least one of the first and second surfaces of the first article and adjacent at least one surface of the second article, thereby positioning the bulk-solidifying amorphous alloy at least partially between the first and second article. The method further includes applying fluid pressure against the bulk-solidifying amorphous alloy to force at least a portion of the alloy between the first and second articles so that at least a portion of the alloy is positioned adjacent both first and second surfaces of the first and second article.

Another preferred embodiment provides a method of joining articles to one another that includes providing at least a first and second article with a space defined therebetween, each first and second article having at least a first surface and at least a second surface on a side of the article opposite the first surface, positioning a bulk-solidifying amorphous alloy material adjacent at least one of the first and second surfaces of the first article and adjacent at least one surface of the second article, thereby positioning the bulk-solidifying amorphous alloy at least partially between the first and second article. The method further includes applying fluid pressure against the bulk-solidifying amorphous alloy to force at least a portion of the alloy between the first and second articles, and applying a force opposing the direction of the fluid pressure force to position the bulk-solidifying amorphous alloy adjacent at least a portion of the other surface of the first and second article.

Throughout this description, the expression “fluid pressure” denotes pressure exerted by a fluid such as water or other liquid, as well as a fluid such as gas. In some embodiments, the fluid could preferably be just liquid and does not include gases. While not intending on being bound by any theory of operation, the inventors believe that the use of liquid pressure to form a bond between articles could provide a unique advantage over pressing the articles together, or use of vacuum or air to force the alloy between the articles to be joined. The embodiments permit joining articles together that are not or can not be readily forced together, such as very small and delicate electronic parts, large articles, items to be joined with gaps at their edges, etc. The use of fluid pressure provides a more even distribution of force on the bulk-solidifying amorphous alloy, and the formation of an interlock in which the alloy material can form around an object. The hydraulic nature of fluids provides for a substantially equal distribution of pressure throughout the fluid, thereby enabling the formation of the interlock joint described herein. Fluid forming the seal using the bulk-solidifying amorphous alloy also permits the formation of a strong joint between articles or between two surfaces, without the need for high temperatures that might cause deformities in the articles being joined.

Bulk-solidifying amorphous alloy systems can exhibit several desirable properties. For example, they can have a high hardness and/or hardness; a ferrous-based amorphous alloy can have particularly high yield strength and hardness. In one embodiment, an amorphous alloy can have a yield strength of about 200 ksi or higher, such as 250 ksi or higher, such as 400 ksi or higher, such as 500 ksi or higher, such as 600 ksi or higher. With respect to the hardness, in one embodiment, amorphous alloys can have a hardness value of above about 400 Vickers-100 mg, such as above about 450 Vickers-100 mg, such as above about 600 Vickers-100 mg, such as above about 800 Vickers-100 mg, such as above about 1000 Vickers-100 mg, such as above about 1100 Vickers-100 mg, such as above about 1200 Vickers-100 mg. An amorphous alloy can also have a very high elastic strain limit, such as at least about 1.2%, such as at least about 1.5%, such as at least about 1.6%, such as at least about 1.8%, such as at least about 2.0%. Amorphous alloys can also exhibit high strength-to weight ratios, particularly in the case of, for example, Ti-based and Fe-based alloys. They also can have high resistance to corrosion and high environmental durability, particularly, for example, the Zr-based and Ti-based alloys.

The bulk-solidifying amorphous alloy useful in forming the interlock joint preferably can have several characteristic temperatures, including glass transition temperature Tg, crystallization temperature Tx, and melting temperature Tm. In some embodiments, each of Tg, Tx, and Tm, can refer to a temperature range, instead of a discrete value; thus, in some embodiments the term glass transition temperature, crystallization temperature, and melting temperature are used interchangeably with glass transition temperature range, crystallization temperature range, and melting temperature range, respectively. These temperatures are commonly known and can be measured by different techniques, one of which is Differential Scanning Calorimetry (DSC), which can be carried out at a heating rate of, for example, about 20° C./min.

In one embodiment, as the temperature increases, the glass transition temperature Tg of an amorphous alloy can refer to the temperature, or temperature ranges in some embodiments, at which the amorphous alloy begins to soften and the atoms become mobile. An amorphous alloy can have a higher heat capacity above the glass transition temperature than it does below the temperature, and thus this transition can allow the identification of Tg. With increasing temperature, the amorphous alloy can reach a crystallization temperature Tx, at which crystals begin to form. As crystallization in some embodiments is generally an exothermic reaction, crystallization can be observed as a dip in a DSC curve and Tx can be determined as the minimum temperature of that dip. An exemplary Tx for a Vitreloy can be, for example, about 500° C., and that for a platinum-based amorphous alloy can be, for example, about 300° C. For other alloy systems, the Tx can be higher or lower. It is noted that at the Tx, the amorphous alloy is generally not melting or melted, as Tx is generally below Tm.

Finally, as the temperature continues to increase, at the melting temperature Tm, the melting of the crystals can begin. Melting is an endothermic reaction, wherein heat is used to melt the crystal with minimal temperature change until the crystals are melted into a liquid phase. Accordingly, a melting transition can resemble a peak on a DSC curve, and Tm can be observed as the temperature at the maximum of the peak. For an amorphous alloy, the temperature difference ΔT between Tx and Tg can be used to denote a supercritical region (i.e., a “supercritical liquid region,” or a “supercritical region”), wherein at least a portion of the amorphous alloy retains and exhibits characteristics of an amorphous alloy, as opposed to a crystalline alloy. The portion can vary, including at least 40 wt %, at least 50 wt %, at least 60 wt %, at least 70 wt %, at least 80 wt %, at least 90 wt %, at least 99 wt %; or these percentages can be volume percentages instead of weight percentages.

Because of their desirable properties, bulk-solidifying amorphous alloys can be used in a variety of applications, including use in the preferred method of joining two articles using pressurized fluid formation techniques. The amount or thickness of the bulk-solidifying amorphous alloy can vary widely, depending on the particular joint being formed. In addition, the joint can be a solid joint, or can be a sheet formed around the surface of the articles being joined, both of which can be formed by varying the thickness of the bulk-solidifying amorphous alloy material used to join the articles together. The bulk-solidifying amorphous alloy material may have a uniform thickness, or the thickness may vary, for example, by being thicker in the areas between the surfaces being joined. The thickness of the bulk-solidifying amorphous alloy can be less than about 10 cm, such as less than about 5 cm, such as less than about 1 cm, such as less than about 5 mm, such as less than about 2 mm, such as less than about 1 mm, such as less than about 500 microns, such as less than about 200 microns, such as less than about 100 microns, such as less than about 50 microns, such as less than about 20 microns, such as less than about 10 microns, such as less than about 1 micron.

The method of the preferred embodiments joins a first and second article to one another, although first and second article may also refer to first and second parts of a single article. In addition, the expression “positioning a bulk-solidifying amorphous alloy” may refer to positioning a separate bulk-solidifying amorphous alloy material, or the bulk-solidifying alloy material may be integral with or formed together with one or more of the articles being joined together. For example, one article may be fabricated with an integral bulk-solidifying amorphous alloy extension (e.g., a flange, flap, or the like) to facilitate bonding that article with another article. Alternatively, one or more articles may be further processed to include a bulk-solidifying amorphous alloy extension to facilitate bonding. Those skilled in the art will be capable of envisioning numerous embodiments in which one or more articles may be fabricated with an integral extension, or may be further processed to contain an extension in which the extension includes one or more bulk-solidifying amorphous alloy materials.

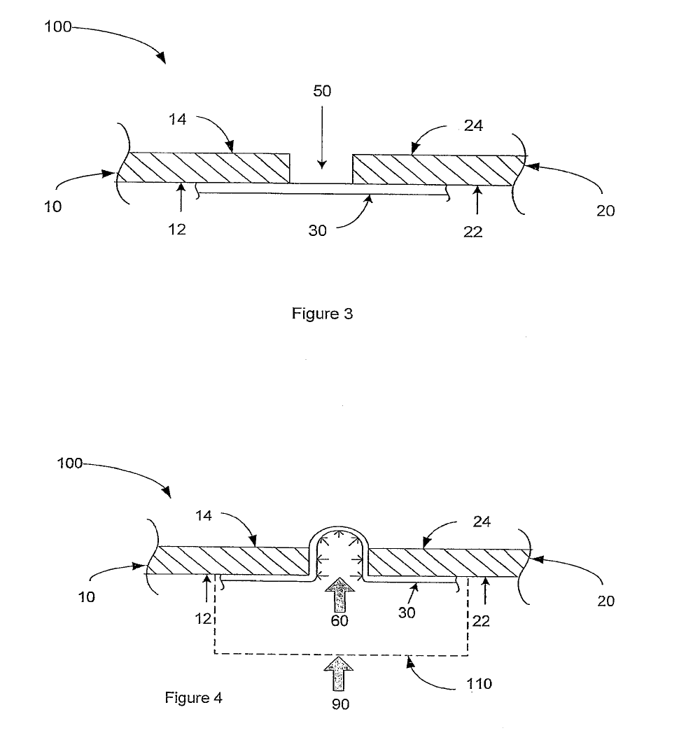

The bulk-solidifying amorphous alloys can form mechanical lock between a plurality of parts to create an intimate seal between the two parts. In one embodiment, the seal can serve as a bonding element between the parts. More than two parts can be used, such as three parts, four parts, five parts, or more. FIG. 3 provides an illustration of the initial seal forming method in accordance with a particularly preferred embodiment. As shown in FIG. 3, the method 100 can be used to join two adjacent articles 10 and 20, having a space 50 therebetween. The size of the space can vary, and the method of the preferred embodiments is capable of joining articles having very minimal space (e.g., 0.05-0.10 mm), or articles having a much larger space 50. Article 10 may have a first surface 12 and a second surface 14, and article 20 can have a corresponding first surface 22 and second surface 24. Those skilled in the art will appreciate that the embodiments are not limited to the specific shape of the articles to be joined, and that the articles may have multiple surfaces. In addition, first (12, 22) and second surfaces (14, 24) may be used interchangeably herein.

The method illustrated in the accompanying figures includes positioning a bulk-solidifying amorphous alloy material 30 adjacent at least one of the surfaces of the articles to be joined. Again, positioning the bulk-solidifying amorphous alloy may include positioning a separate alloy material 30, or the material may be an integral part of article 10, 20 (or more articles), or article 10, 20 (or more articles) may be processed to include alloy material 30. FIG. 3 illustrates alloy material 30 positioned adjacent first surface 12 of article 10, and first surface 22 of article 20. Positioned adjacent denotes positioning the material near the surface or on the surface, as the case may be. Bulk-solidifying amorphous alloy material 30 may be in any shape suitable for joining articles using the guidelines provided herein. As stated above, the alloy material 30 may have a uniform thickness, or the thickness may vary, whereby the thickness may be greater at or near the space 50 formed between first and second articles 10, 20. The alloy material 30 also may be in the form of a sheet, a wire, a cylinder, a rectangular or square patch, a blob, or any other shape suitable for forming the joint between articles 10 and 20.

The method can include heating an already formed bulk-solidifying amorphous alloy material 30 to a first temperature that is below Tx of the composition. In a preferred embodiment, little or no heating is required, and the heat may be supplied by the pressurized fluid. If heat is applied during the method 100 of forming the joint between articles 10 and 20, then after the joint is formed, the method would include cooling the heated bulk-solidifying amorphous alloy 30 to form the final seal.

The method 100 further includes subjecting the optionally heated bulk-solidifying amorphous alloy material 30 to pressurized fluid, as shown in FIG. 4. FIG. 4 shows fluid pressure 60 being applied to bulk-solidifying amorphous alloy material 30, causing it to deform and push through the space 50 previously existing between articles 10 and 20, thereby occupying the space. Fluid pressure 60 optionally can be applied using a sealed containment system 110, in which case the fluid pressure 90 can be applied in a hydraulic press similarly to known hydroforming techniques. Optional containment system preferably is positioned at or near space 50 to direct fluid pressure only in the area in which bulk-solidifying amorphous alloy material 30 is intended to be deformed.

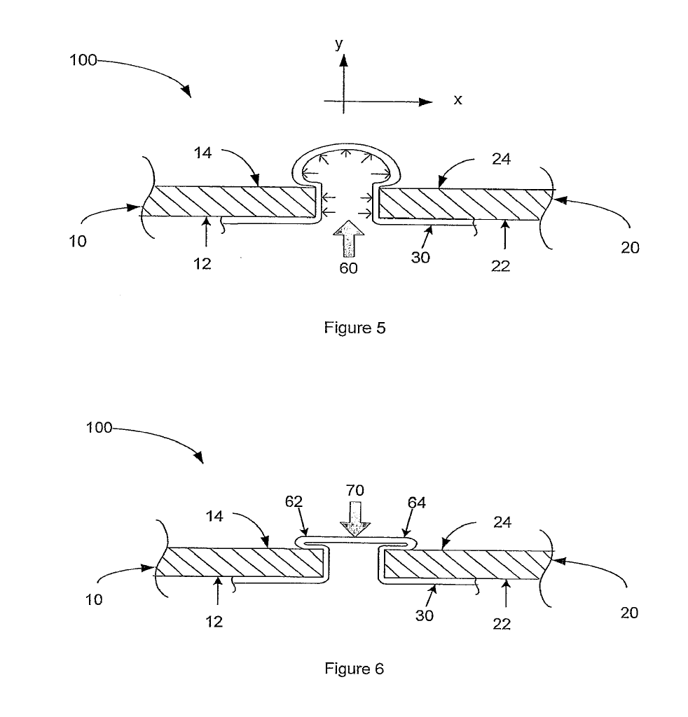

FIG. 5 illustrates method 100 in its final stage in which bulk-solidifying amorphous alloy material 30 has been fully deformed so that it now is positioned adjacent both first and second surfaces 12, 14 of article 10, and first and second surfaces 22, 24 of article 20. The bulk-solidifying amorphous alloy material is capable of being deformed in the manner shown in FIG. 5 by virtue of fluid pressure acting relatively equally across the bulk-solidifying amorphous alloy material 30, as shown by the arrows. This configuration of the joint forms a mechanical interlock between articles 10 and 20, restricting movement in both the x and y planes. Most methods of joining articles that employ solder-like material, and even those that employ air pressure only form a seal or mechanical lock that restricts movement only in the x direction. Accordingly, known joining techniques may produce a joint that can break or become damaged if articles 10 and 20 move relative to one another in the y direction, such movement being caused by differential thermal expansion, or physical movement. The mechanical interlock made possible by use of fluid pressure 60 applied to a bulk-solidifying amorphous alloy material 30 therefore represents a significant improvement when compared to conventional joining techniques.

An optional final processing procedure may be carried out as shown in FIG. 6 in which a force 70 is applied in a direction generally opposite the original fluid force 60 to flatten out a portion of deformed bulk-solidifying alloy material 30 and form flanges 62, 64 adjacent second surface 14 of article 10 and second surface 24 of article 20, respectively. Force 70 may be applied by any manner known in the art, including pressing using a press, fluid or air flow, and the like. While FIG. 6 depicts the joint as having a relatively planar upper surface forming flanges 62, 64, the upper surface could be deformed inwardly toward space 50. In addition, the figures show a space between articles 10 and 20 still existing after the joint has been formed, which may or may not occur. Moreover, the joint may be formed as a sheet like material as shown in the Figures, or the area between articles 10 and 20 may be filled entirely with alloy material 30, or this area may be back-filled with other suitable material, as the case may be.

FIG. 7 illustrates a fully formed interlock, including the optional pressing shown in FIG. 7, in which no space 50 exists between articles 10 and 20. As shown, flanges 62 and 64 prevent movement of articles 10 and 20 in the +y direction, bulk-solidifying amorphous alloy material 30 positioned adjacent first surfaces 12, 22 of first and second articles 10, 20, respectively, restricts movement in the −y direction, and the bulk-solidifying amorphous alloy material positioned between articles 10 and 20 restricts movement in the x direction. The joint formed by bulk-solidifying amorphous alloy material in accordance with the preferred embodiments therefore forms a more secure joint, preventing x and y relative movement. Because the mechanical interlock is formed using a bulk-solidifying amorphous alloy material 30, the joint may be more flexible than articles 10 and 20, thus permitting some relative movement without creating too much strain on the respective materials (articles and amorphous alloy) to cause fatigue or failure. Bulk-solidifying amorphous alloy material 30 is capable of being deformed to a much greater extent than crystalline materials, thereby creating a secure joint that can maintain its integrity over a greater period of time even when articles 10 and 20 move relative to one another.

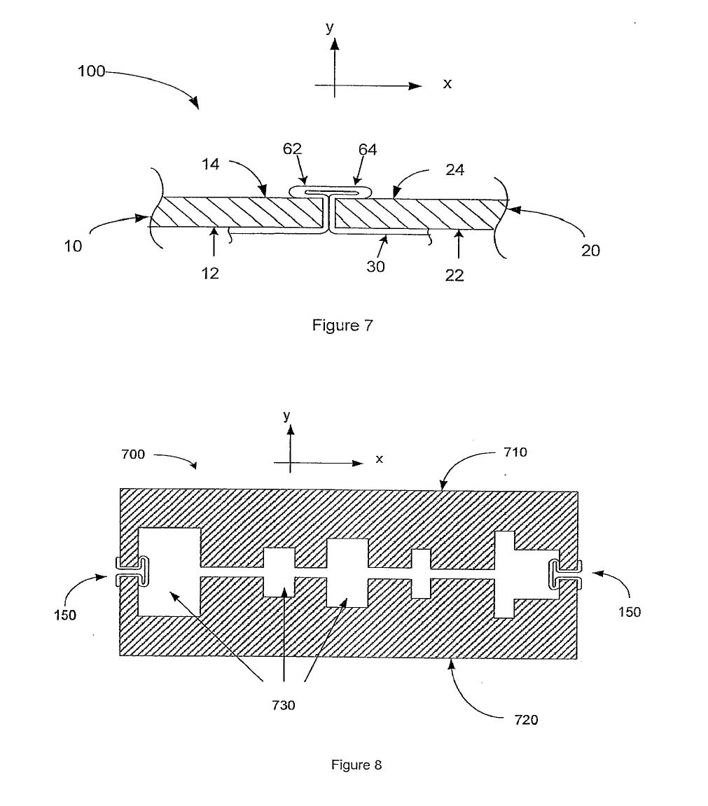

FIG. 8 illustrates one embodiment in which an article 700 is formed that includes a first article 710 and a second article 720. These articles may be, for example, stacked printed circuit boards providing through or via holes 730 for disposition of circuit elements, or may be stacked fuel cells with openings 730 for passage of fuel or air. The respective openings 730 may of the same or different shape. Conventional bonding techniques for these types of materials do not provide the inventive mechanical interlock 150, and consequently, allow for significant relative movement in the x direction, which can cause fatigue and failure of the joint. The mechanical interlock 150 of the preferred embodiments restricts such movement, and because of the amorphous nature of the alloy material used to form the joint, permits some movement due to differing thermal expansion coefficients, physical movement, and the like, without causing fatigue or failure of the interlock 150.

In one embodiment wherein a thin bulk-solidifying amorphous alloy material 30 is used to form the seal, the seal can simultaneously function as a bonding element that bonds the two parts together, and as a hermetic seal. A hermetic seal can refer to an airtight seal that also is impermeable to fluid or micro organisms. The seal can be used to protect and maintain the proper function of the protected content inside the seal.

Depending on the application, the respective articles 10, 20 (or more) that are joined together using mechanical interlock 150 can be made of any material. For example, the material can include a metal, a metal alloy, a ceramic, a cermet, a polymer, or combinations thereof. The part or substrate can be of any size or geometry. For example, articles 10, 20 (or more) can be shots, a sheet, a plate, a cylinder, a cube, a rectangular box, a sphere, an ellipsoid, a polyhedron, or an irregular shape, or anything in between. Accordingly, the surfaces of the articles upon which the mechanical interlock 150 is formed can have any geometry, including a square, a rectangle, a circle, an ellipse, a polygon, or an irregular shape.

The articles 10, 20 (or more) also may have a recessed surface or surfaces. The recessed surface can include an undercut or a cavity, and may have a predetermined geometry. The article can be solid or hollow. In one embodiment wherein the article is hollow, such as a hollow cylinder, a recessed surface may be on the interior surface or exterior surface of the part. In other words, the mechanical interlock 150 can form on the interior surface or the exterior surface of the article, and preferably is formed on both surfaces. In some embodiments, the article surface can have a roughness of any desirable size to facilitate the formation of the mechanical interlock 150. For example, the first article can be a bezel for a watch or an electronic device housing with an undercut. Alternatively, it can have at least one cavity or undercut of random size or geometry. For example, the first article can be a mold or die (e.g., for extrusion) for the composition therein, and thus the cavity refers to the cavity space of the mold or die. In another embodiment, the first article can be the outer shell of an electrical connector that has a hollow cylindrical shape.

Multiple articles can be used. In one embodiment, joint made in accordance with the embodiments can create an intimate seal between the amorphous alloy material 30 with a surface or surfaces (12, 14) of a first article 10 and simultaneously with a surface or surfaces (22, 24) of a second article 20. The bulk-solidifying amorphous alloy material 30 effectively can serve as a bonding element between the two articles. The surface of each or some the articles can have roughness or recessed surface (e.g., undercut or cavity).

The two articles can be vertically aligned, horizontally aligned, or not aligned. The two articles can be joined perpendicularly to each other or parallel to each other. Also, one article can be inside of the other. For example, the first article may have a hollow shape (e.g., cylinder or rectangular box) and the second article can be a wire or smaller diameter cylinder inside the hollow space of the first article. In this embodiment, the mechanical interlock 150 may form a circumferential seal (partially around the circumference or around the entire circumference) between the respective cylindrical articles. Alternatively, the mechanical interlock 150 can be used to join two articles (10, 20, or 710, 720) of the same size and/or geometry or different size and/or geometry. For example, in one embodiment, the mechanical interlock 150 can be used to join two pieces of the housing of an electronic device, whereby the mechanical interlock 150 may simultaneously serve as a fluid-impermeable seal between the two parts.

Depending on the application, the articles can be made of any suitable materials. For example, each or at least one of the articles can include a material that is crystalline, partially amorphous, substantially amorphous, or fully amorphous. The articles may have the same or different microstructure as the bulk-solidifying amorphous alloy that is positioned thereon (or formed integrally therewith) to form the joint. For example, they can be amorphous, substantially amorphous, partially amorphous, or crystalline, or they can be different. The amorphous composition of the articles can be a homogeneous amorphous alloy or a composite having an amorphous alloy. In one embodiment, the composite can include an amorphous matrix phase surrounding a crystalline phase, such as a plurality of crystals. The crystals can be in any shape, including having a dendritic shape.

The articles also may include an inorganic material, an organic material, or a combination thereof. The article can include a metal, a metal alloy, a ceramic, or combinations thereof. The article can also be a composite with various materials combined together or be of essentially one material. Depending on the application, in some embodiments, the article(s) can include a material that has a softening temperature higher than the Tg of the bulk-solidifying amorphous alloy material 30 that will be positioned thereon to form the joint. The softening temperature in the context of the article(s) can refer to the Tg thereof (in the case of an amorphous material) or the melting temperature Tm (in the case of a crystalline material). In the case of a mixture of amorphous material and crystalline material, the softening temperature can refer to the temperature at which the atoms in the material begin to become mobile, such as Tg or a temperature between Tg and Tm. In one embodiment, the article(s) can have a softening temperature that is higher than the crystallization temperature, or in some embodiments, the melting temperature, of the amorphous alloy material 30. In one embodiment, the article(s) can include a material that has a softening temperature that is above about 300° C., preferably above about 200° C., more preferably above about 100° C.; for example, the article(s) can be used with a platinum-based alloy. In another embodiment, the article can comprise a material that has a softening temperature that is above about 500° C.; for example, the article can be used with a zirconium based alloy. The article can comprise diamond, carbide (e.g., silicon carbide), or a combination thereof.

Depending on the application, the article(s) can be a part of an electronic device or any type of article that can utilize the benefits of having the aforedescribed mechanical interlock 150. Because of the intimate contact provided by the mechanical interlock and seal, it can be used for a variety of applications. The mechanical interlock 150 can function as a solder mass, case sealing, electrical lead for air tight or water-proof application, rivet, bonding, fastening parts together. For example, in one embodiment wherein a mechanical interlock comprised of a bulk-solidifying amorphous alloy is formed between a metal-containing wire that is protruding out of a hollow cylinder, the seal can provide a water-proof and air-tight seal. Such a seal can be a hermetic seal. Also, the aforedescribed wire and cylinder assembly can be a part of various devices. For example, it can be a part of a bio-implant. For example, in the case of a Cochlear implant, the seal used for water/air tight seal and electrical/signal conductor. Alternatively, the seal can be used to seal a diamond window in analytical equipment. In another embodiment, the seal is a part of an electrical connector, with the first hollow part, for example, being the outer shell thereof.

Alternatively, the mechanical interlock can form a of an electronic device, such as, for example, a part of the housing of the device or an electrical interconnector thereof. For example, in one embodiment, the mechanical interlock can be used to connect and bond two parts of the housing of an electronic device and create a seal that is impermeable to fluid, effectively rendering the device water proof and air tight such that fluid cannot enter the interior of the device.

While the invention has been described in detail with reference to particularly preferred embodiments, those skilled in the art will appreciate that various modifications may be made thereto without significantly departing from the spirit and scope of the invention.

What is claimed:

1. A method of joining comprising:
providing at least a first and a second article with a space defined therebetween, each of the first and second article having at least a first surface and at least a second surface on a side of the article opposite the first surface;
positioning a bulk-solidifying amorphous alloy material adjacent at least one of the first and second surfaces of the first article and adjacent at least one of the first and second surfaces of the second article, thereby positioning the bulk-solidifying amorphous alloy at least partially between the first and second article; and
applying fluid pressure against the bulk-solidifying amorphous alloy to force at least a portion of the alloy between the first and second articles so that at least a portion of the alloy is positioned adjacent both first and second surfaces of the first and second article, thereby forming a joint between a first and second article.

2. The method as claimed in claim 1, further comprising heating the bulk-solidifying amorphous alloy to a temperature between the glass transition temperature (Tg) and the crystallization temperature (Tx) of the alloy prior to applying fluid pressure.

3. The method as claimed in claim 1, wherein applying fluid pressure comprises applying a heated fluid that heats the bulk-solidifying amorphous alloy.

4. The method as claimed in claim 1, wherein the bulk-solidifying amorphous alloy is not heated prior to applying fluid pressure.

5. The method as claimed in claim 1, wherein applying fluid pressure comprises forcing fluid against at least a portion of the bulk-solidifying amorphous alloy in a sealed containment system.

6. The method as claimed in claim 1, wherein the bulk-solidifying amorphous alloy is a separate material from the first and second article.

7. The method as claimed in claim 1, wherein the bulk-solidifying amorphous alloy forms a part of at least the first or second article.

8. The method as claimed in claim 1, wherein the bulk-solidifying amorphous alloy forms at least one flange adjacent a first or second surface of at least one of the first and second articles.

9. The method as claimed in claim 8, wherein the bulk-solidifying amorphous alloy forms at least one flange adjacent a first or second surface of the first article, and at least one flange adjacent a first or second surface of the second article.

10. The method as claimed in claim 1, wherein the alloy is described by the following molecular formula: (Zr, Ti)ₐ(Ni, Cu, Fe)_{b}(Be, Al, Si, B)_{c}, wherein “a” is in the range of from 30 to 75, “b” is in the range of from 5 to 60, and “c” is in the range of from 0 to 50 in atomic percentages.

11. The method as claimed in claim 1, wherein the alloy is described by the following molecular formula: (Zr, Ti)ₐ(Ni, Cu)_{b}(Be)_{c}, wherein “a” is in the range of from 40 to 75, “b” is in the range of from 5 to 50, and “c” is in the range of from 5 to 50 in atomic percentages.

12. The method as claimed in claim 1, wherein the bulk solidifying amorphous alloy can sustain strains up to 1.5% or more without any permanent deformation or breakage.

13. A method of joining comprising:
providing at least a first and a second article with a space defined therebetween, each of the first and second article having at least a first surface and at least a second surface on a side of the article opposite the first surface;
positioning a bulk-solidifying amorphous alloy material adjacent at least a first surfaces of the first article and adjacent at least a first surface of the second article, thereby positioning the bulk-solidifying amorphous alloy at least partially between the first and second article;
applying fluid pressure against the bulk-solidifying amorphous alloy to force at least a portion of the alloy between the first and second articles; and
applying a force in a direction generally opposite the direction of the fluid pressure force to position at least a portion of the bulk-solidifying amorphous alloy adjacent at least a portion of the second surface of the first article and to position at least a portion of the bulk-solidifying amorphous alloy adjacent at least a portion of the second surface of the second article.

14. The method as claimed in claim 13, further comprising heating the bulk-solidifying amorphous alloy to a temperature between the glass transition temperature (Tg) and the crystallization temperature (Tx) of the alloy prior to applying fluid pressure.

15. The method as claimed in claim 13, wherein applying fluid pressure comprises applying a heated fluid that heats the bulk-solidifying amorphous alloy.

16. The method as claimed in claim 13, wherein the bulk-solidifying amorphous alloy is not heated prior to applying fluid pressure.

17. The method as claimed in claim 13, wherein applying fluid pressure comprises forcing fluid against at least a portion of the bulk-solidifying amorphous alloy in a sealed containment system.

18. The method as claimed in claim 13, wherein the bulk-solidifying amorphous alloy is a separate material from the first and second article.

19. The method as claimed in claim 13, wherein the bulk-solidifying amorphous alloy forms a part of at least the first or second article.

20. The method as claimed in claim 13, wherein the bulk-solidifying amorphous alloy forms at least one flange adjacent the second surface of the first article, and at least one flange adjacent the second surface of the second article.

21. The method as claimed in claim 13, wherein the alloy is described by the following molecular formula: (Zr, Ti)ₐ(Ni, Cu, Fe)_{b}(Be, Al, Si, B)_{c}, wherein “a” is in the range of from 30 to 75, “b” is in the range of from 5 to 60, and “c” is in the range of from 0 to 50 in atomic percentages.

22. The method as claimed in claim 13, wherein the alloy is described by the following molecular formula: (Zr, Ti)ₐ(Ni, Cu)_{b}(Be)_{c}, wherein “a” is in the range of from 40 to 75, “b” is in the range of from 5 to 50, and “c” is in the range of from 5 to 50 in atomic percentages.

23. The method as claimed in claim 13, wherein the bulk solidifying amorphous alloy can sustain strains up to 1.5% or more without any permanent deformation or breakage.

24. A component of an electronic device comprising a first article, a second article and a joint, wherein the joint comprises a bulk solidifying amorphous alloy and the joint connects the first article to the second article.

25. The component of claim 24, wherein the first and second articles are stacked printed circuit boards.

26. The component of claim 24, wherein the first and second articles have respective openings and the joint traverses through the openings.

27. The component of claim 24, wherein the joint allows for significant relative movement of the first article and/or the second article.
